(19) United States
(12) Patent Application Publication
(10) Pub. No.: US 2024/0028913 A1
(43) Pub. Date: Jan. 25, 2024

(54) HEURISTIC-BASED INTER-TRAINING WITH FEW-SHOT FINE-TUNING OF MACHINE LEARNING NETWORKS

(71) Applicant: International Business Machines Corporation, Armonk, NY (US)

(72) Inventors: Benjamin SZNAJDER, Jerusalem (IL); Noam SLONIM, Jerusalem (IL); Eyal SHNARCH, Haifa (IL); Guy LEV, Tel Aviv (IL); Sachindra JOSHI, Gurgaon (IN); Chulaka GUNASEKARA, New Hyde Park, NY (US)

(21) Appl. No.: 17/870,561

(22) Filed: Jul. 21, 2022

(51) Int. Cl. G06N 5/02

(52) U.S. Cl. CPC G06N 5/022

(57) ABSTRACT

An example system includes a processor to receive unlabeled data, few-shot training data, and a pre-trained model. The processor can split the unlabeled data into a number of groups corresponding to different perspectives. The processor can generate weakly labeled data for each of the number of groups using a respective associated heuristic. The processor can inter-train a model for each different perspective based on respective weakly labeled data. The processor can fine-tune each inter-trained model based on the few-shot training data for each different perspective to generate a final model for each different perspective.

### BACKGROUND

The present techniques relate to training machine learning networks. More specifically, the techniques relate to training machine learning networks with unlabeled data.

### SUMMARY

According to an embodiment described herein, a system can include processor to split unlabeled data into a plurality of groups corresponding to different perspectives. The processor can also further generate weakly labeled data for each of the plurality of groups using a respective associated heuristic. The processor can also inter-train a pre-trained model for each perspective based on respective weakly labeled data. The processor can fine-tune each inter-trained model based on few-shot training data for each different perspective to generate a final model for each different perspective

According to another embodiment described herein, a method can include receiving, via a processor, unlabeled data, few-shot training data, and a pre-trained model. The method can further include splitting, via the processor, the unlabeled data into a plurality of groups corresponding to different perspectives. The method can also further include generating, via the processor, weakly labeled data for each of the plurality of groups using a respective associated heuristic. The method can also include inter-training, via the processor, the pre-trained model for each different perspective based on respective weakly labeled data. The processor can include fine-tuning, via the processor, each inter-trained model based on the few-shot training data for each different perspective to generate a final model for each different perspective.

According to another embodiment described herein, a computer program product for training machine learning networks can include computer-readable storage medium having program code embodied therewith. The program code executable by a processor to cause the processor to receive unlabeled data, few-shot training data, and a pre-trained model. The program code can also cause the processor to split the unlabeled data into a plurality of groups corresponding to different perspectives. The program code can also cause the processor to generate weakly labeled data for each of the plurality of groups using a respective associated heuristic. The program code can also cause the processor to inter-train the pre-trained model for each different perspective based on respective weakly labeled data. The program code can also cause the processor to fine-tune each inter-trained model based on the few-shot training data for each different perspective to generate a final model for each different perspective.

### BRIEF DESCRIPTION OF THE SEVERAL VIEWS OF THE DRAWINGS

FIG. 1 is a block diagram of an example system for inter-training a machine learning network;

FIG. 2 is a block diagram of an example system for generating summaries of conversations using a machine learning network trained with heuristic-based inter-training;

FIG. 3 is a process flow diagram of an example method that can train machine learning models using heuristic-based inter-training;

FIG. 4 is a process flow diagram of an example method that can summarize input conversations using models trained using heuristic-based inter-training;

FIG. 5 is a block diagram of an example computing device that can perform heuristic-based inter-training of a machine learning network;

FIG. 6 is a diagram of an example cloud computing environment according to embodiments described herein;

FIG. 7 is a diagram of an example abstraction model layers according to embodiments described herein; and

FIG. 8 is an example tangible, non-transitory computer-readable medium that can perform heuristic-based inter-training of a machine learning network.

### DETAILED DESCRIPTION

Machine learning networks may be trained to provide summaries of conversations. However, the training data available for the training of such machine learning networks may include very few labeled instances or incorrectly labeled instances of training data. For example, correctly labeled data may be a conversation with an associated summary of the conversation. Moreover, existing methods may require large amounts of labeled data including summaries for training and manually generating such summaries may be time consuming and sometimes inaccurate.

According to embodiments of the present disclosure, a system includes a processor to receive unlabeled data, few-shot training data, and a pre-trained model. The processor can split the unlabeled data into a number of groups corresponding to different perspectives. The processor can generate weakly labeled data for each of the number of groups using a respective associated heuristic. The processor can inter-train a model for each different perspective based on respective weakly labeled data. The processor can fine-tune each inter-trained model based on the few-shot training data for each different perspective to generate a final model for each different perspective. Thus, embodiments of the present disclosure enable training of models to automatically generate multi-perspective summaries of conversations using a very small amount of annotated data during training. For example, the techniques described herein were shown to achieve 94% of the performance measured using Rouge-2 of the Rouge-L-F-measure quality measure of a model trained with the original data, but by training the new model using only 7% of the original training data set.

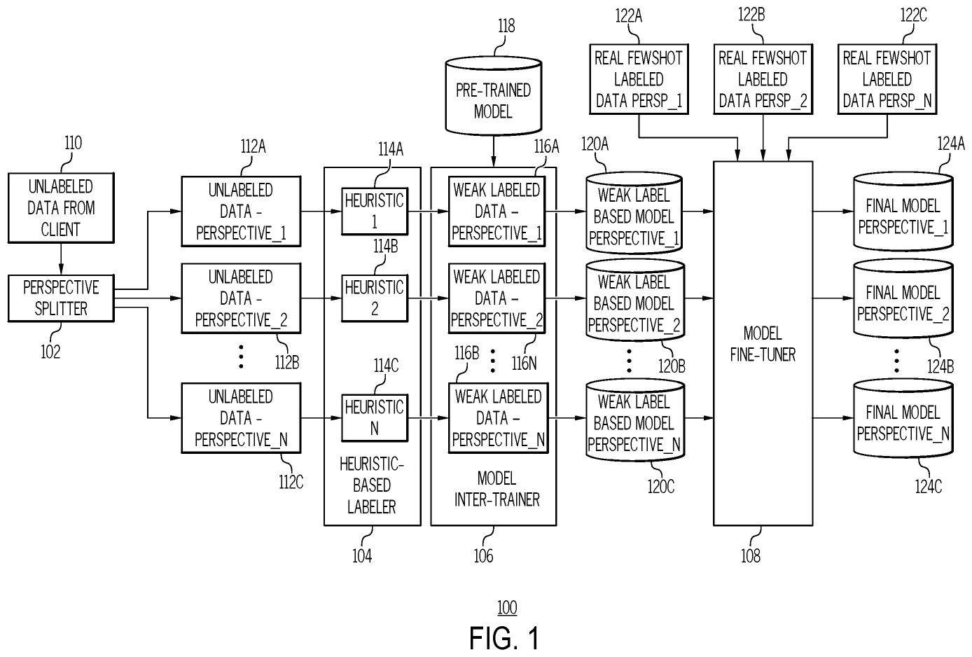

With reference now to FIG. 1, a block diagram shows an example system for inter-training a machine learning network. The example system is generally referred to by the reference number 100. The system 100 of FIG. 1 includes a perspective splitter 102. The system includes a heuristic-based labeler 104 communicatively coupled to the perspective splitter 102. The system 100 also include a model inter-trainer 106 communicatively coupled to the heuristic-based labeler 104. The system 100 further includes a model fine-tuner 108 communicatively coupled to the model inter-trainer 106.

The perspective splitter 102 is shown receiving unlabeled data 110 and generating groups of unlabeled data organized by perspectives 112A, 112B, and 112C. In various examples, the unlabeled data 110 may be a large number of example conversations received from a client.

The heuristic-based labeler 104 further includes a set of heuristics 114A, 114B, and 114C. For example, the heuristics 114A, 114B, and 114C may be associated with the unlabeled data perspectives 112A, 112B, and 112C, respectively. In various examples, a heuristic may be separately defined for each of the unlabeled data perspectives 112A, 112B, and 112C. In various examples, the heuristic-based labeler 104 may receive the unlabeled data perspectives 112A, 112B, and 112C and generate weakly labeled data 116A, 116B, and 116C. For example, the weakly labeled data 116A, 116B, and 116C may be summaries of the unlabeled data perspectives 112A, 112B, and 112C. In various examples, any suitable heuristics 114A, 114B, 114C may be used to label the unlabeled data perspectives 112A. For example, the heuristics 114A, 114B, and 114C may include a lead heuristic and a long heuristic. A lead heuristic, as used herein, refers to a heuristic in which the first utterance of a perspective that contains at least five tokens is taken as a summary of a given perspective. For example, a token may be a word. For example, the tokens may be words. A long heuristic, as used herein, refers to a heuristic in which the longest utterance of a given perspective is selected as the respective summary. For example, the length of the utterance may be measured in tokens. Both of these heuristics may be used to efficiently extract weak summaries for each of the perspectives 112A, 112B, and 112C. In various examples, any other suitable heuristics may be used.

As shown in FIG. 1, the model inter-trainer 106 can receive a pre-trained model 118 and weakly labeled data 116A, 116B, and 116C, and generate a number of associated weak label-based models 120A, 120B, and 120C. For example, the model inter-trainer 106 can inter-train the pre-trained model 118 to generate weak label-based models 120A, 120B, and 120C using the weakly labeled data 116A, 116B, and 116C, respectively. In various examples, the pre-trained model 118 may be any suitable pre-trained generative model, such as the DistillPegasus model, first released in 2020. In particular, given a dialog, the model inter-trainer 106 can separately train the pre-trained model 118 to generate respective weak summaries 116A, 116B, and 116C, resulting in inter-trained weak label-based models 120A, 120B, and 120C. In some examples, the target utterance may be masked during inter-training. For example, the target utterance may be the longest utterance or lead utterance in the example of the use of long and lead heuristics. In this manner, the model inter-trainer 106 can train the model 118 to locate the most important part of an input dialog for each perspective and output it as a summary. Such the weak label-based models 120A, 120B, and 120C may tend towards extractive summarization due to the nature of the data that they are inter-trained on. This tendency may be altered and corrected by the model fine-tuner 108 as described below.

The model fine-tuner 108 includes real few-shot labeled data perspectives 122A, 122B, and 122C. For example, the real few-shot labeled data perspectives 122A, 122B, and 122C may be based on real few-shot labeled data received from a client. For example, the real few-shot labeled data perspectives 122A, 122B, and 122C may include 64 samples or less. In some examples, more samples may be used to achieve even better results. The model fine-tuner 108 can fine-tune the weak label-based models 120A, 120B, and 120C on the real few-shot labeled data perspectives 122A, 122B, and 122C to generate final models 124A, 124B, and 124C. For example, the model fine-tuner 108 may further train the weak label-based models 120A, 120B, and 120C using the real few-shot labeled data perspectives 122A, 122B, and 122C, respectively. The fine-tuning may enable the resulting final models 124A, 124B, and 124C to learn to generate an abstractive third-person summary. Moreover, this learning is achieved using only few-shot fine-tuning and is thus very efficiently trained.

Still referring to FIG. 1, as one specific example in a multi-perspective dialog between customers and support agents, the unlabeled data perspectives 112A and 112B may include a perspective from a customer 112A including utterances from the customer and a perspective from an agent 112B including utterances from the agent. The heuristic 114A may be a lead heuristic used to detect questions and the heuristic 114B may be a long heuristic used to detect answers. The heuristic-based labeler 104 may thus use heuristics 114A and 114B to generate weakly labeled data 116A including a question and weakly labeled data 116B including a longest sentence, for each of the conversations in unlabeled data 110 from the customer perspective 112A and agent perspective 112B, respectively. The model inter-trainer 106 can inter-train the pre-trained model 118 on weakly labeled data 116A to generate a first weak label-based model 120A for the customer and on the weakly labeled data 11B to generate a second weak label-based model 120B for the agent. For example, the pre-trained model may be the DistillPegasus model. The model fine-tuner 108 can then fine-tune the first weak label-based model 120A on real few-shot labeled data 122A. For example, the real few-shot labeled data 122A may include summaries and associated conversations from the perspective of a customer. The model fine-tuner 108 cam similarly fine-tune the second weak label-based model 120B on real few-shot labeled data 122B. For example, the real few-shot labeled data 122B may include summaries and associated conversations from the perspective of an agent. As one example, the few-shot training data my include 64 or less samples. The fine-tuning may result in final models 124A and 124B for the customer and agent perspectives, respectively. For example, the final model 124A may summarize a customer's need raised in a given dialog and the final model 124B may summarize the answer provided by the agent for the need of the customer.

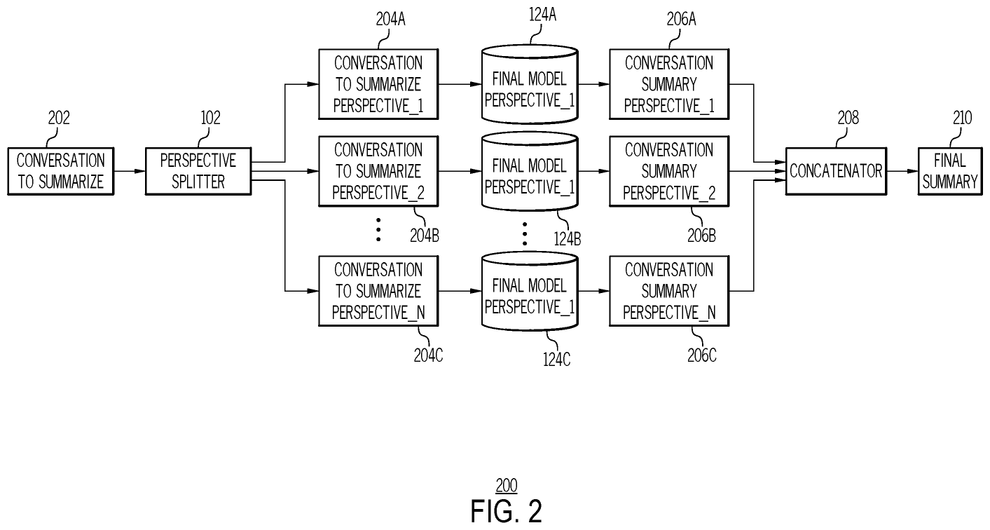

In various examples, the final models 124A and 124B may be used during inference to summarize input dialogs, as described in the example of FIG. 2 below. The techniques thus enable fine-tuning using a small amount of few-shot training data, while maintaining accuracy of the resulting final models 124A and 124B used to be used to generate summaries at inference.

It is to be understood that the block diagram of FIG. 1 is not intended to indicate that the system 100 is to include all of the components shown in FIG. 1. Rather, the system 100 can include fewer or additional components not illustrated in FIG. 1 (e.g., additional client devices, or additional resource servers, etc.).

FIG. 2 is a block diagram shows an example system for generating summaries of conversations using a machine learning network trained with heuristic-based inter-training. The example system is generally referred to by the reference number 200. FIG. 2 includes similarly numbered elements from FIG. 1. In particular, the system 200 includes a perspective splitter to receive a conversation to summarize 202 and split the conversation 202 into groups associated with different perspectives 204A, 204B, and 204C. For example, each of the groups 204A, 204B, and 204C may include a list of sentences associated with a particular different perspective. The system 200 also includes final models 124A, 124B, and 124C. For example, the final models 124A, 124B, and 124C may have been trained using the system 100 of FIG. 1. In various examples, the final models 124A, 124B, and 124C may receive as input the groups 204A, 204B, and 204C and output conversation perspective summaries 206A, 206B, 206C for each of the perspectives. The system 200 further includes a concatenator 208 communicatively coupled to the final models 124A, 124B, and 124C. For example, the concatenator 208 can receive the conversation perspective summaries 206A, 206B, 206C and output a final summary 210. The final summary 210 may thus be a concatenation of the conversation perspective summaries 206A, 206B, 206C.

In the example of FIG. 2, the perspective splitter 102 can split a received conversation 202 into a number of groups corresponding to different perspectives. For example, the groups may each include a list of sentences associated with a particular perspective. As one examples, the groups may include a first group 204A associated with an agent perspective and a second group 204B associated with a customer perspective. In various examples, any number of additional perspectives may be included, as indicated by ellipses and group 204C.

The final models 124A, 124B, and 124C may each receive a group 204A, 204B, 204C, respectively, corresponding to a particular different perspective and output a conversation perspective summary 206A, 206B, 206C, respectively, for the particular different perspective. Thus, each of the conversation perspective summaries 206A, 206B, 206C may be a summary of the conversation 202 from a particular different perspective.

In some examples, the generated conversation perspective summaries 206A, 206B, and 206C may be post-processed before concatenation by the concatenator 208. For example, in response to detecting that a conversation perspective summary does not begin with a prefix of indirect speech clause, a post-processing unit (not shown) may add a prefix of indirect speech clause to the conversation perspective summary. As one example, the prefix of indirect speech clause for the example of customer and agent described in FIG. 1, would be “The customer asks:” for customer perspective summaries and “The agent answers:” for agent perspective summaries. In this example, such prefix of indirect speech clause may be added to customer perspective summaries and agent perspective summaries, respectively, in response to detecting that the summaries do not start with the prefix “[The] Customer/Agent”. In various examples, such post-processing may be particularly applied where lesser numbers of labeled examples are available to be used as real few-shot labeled data are available during training.

It is to be understood that the block diagram of FIG. 2 is not intended to indicate that the system 200 is to include all of the components shown in FIG. 2. Rather, the system 200 can include fewer or additional components not illustrated in FIG. 2 (e.g., additional conversations to summarize, perspectives, final models, or additional final summaries, etc.).

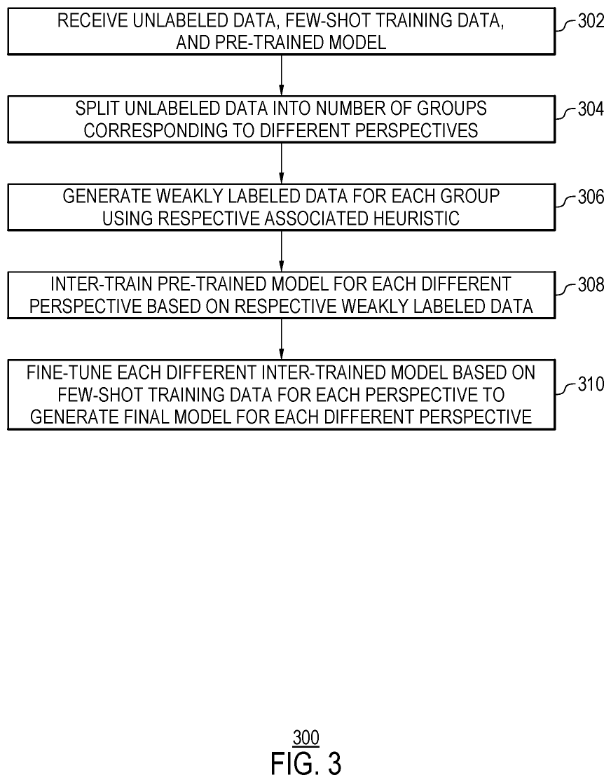

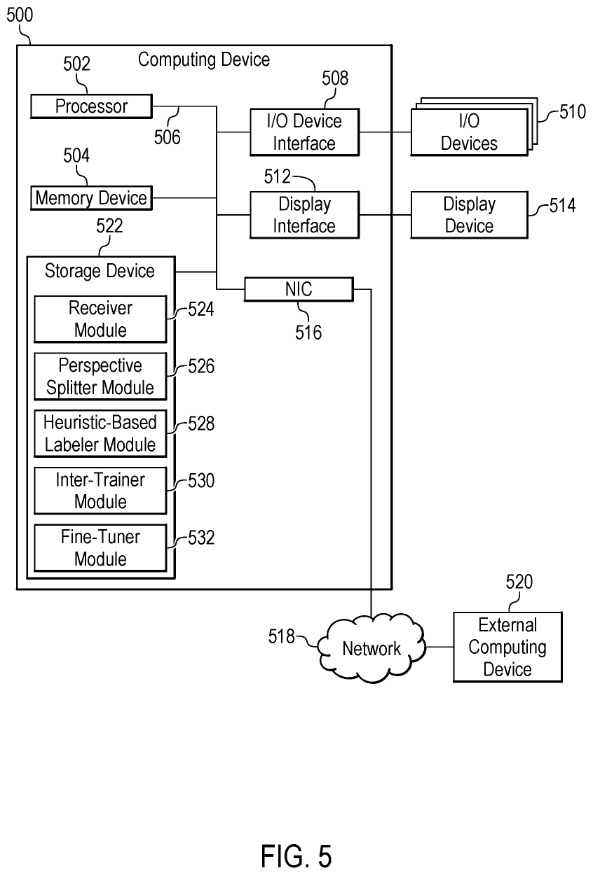

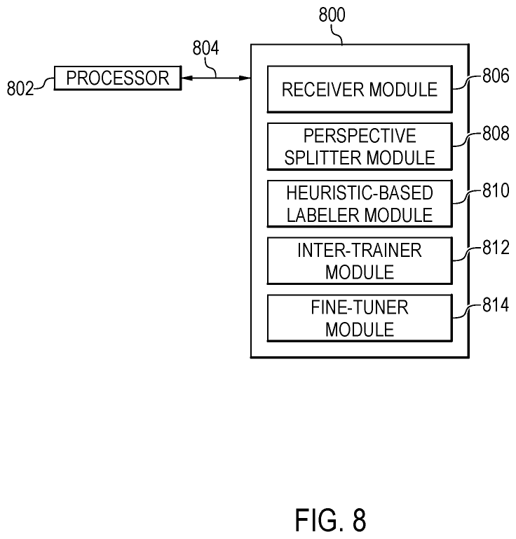

FIG. 3 is a process flow diagram of an example method that can train machine learning models using heuristic-based inter-training. The method 300 can be implemented with any suitable computing device, such as the computing device 300 of FIG. 3 and is described with reference to the system 100 of FIG. 1. In various examples, the methods described below can be implemented by the processor 502 or the processor 802 of FIGS. 5 and 8.

At block 302, a processor receives unlabeled data, few-shot training data, and a pre-trained model. For example, the unlabeled data may include a large set of unlabeled conversations. The few-shot training data may include a smaller set of labeled conversation summaries. For example, the few-shot training data may include conversation summaries from a number of perspectives. As one example, the few-shot training data my include 64 or less labeled samples. In various examples, the number of conversations summaries in the few-shot training data may be much smaller than the number of unlabeled conversations. In various examples, the pre-trained model may be any suitable pre-trained generative model, such as the DistillPegasus model.

At block 304, the processor splits the unlabeled data into a number of groups corresponding to different perspectives. For example, the different perspectives may include an agent perspective and a customer perspective, among other perspectives.

At block 306, the processor generates weakly labeled data for each of the number of groups using a respective associated heuristic. For example, the weakly labeled data may be a weak summary generated for each group using the respective associated heuristic. In various examples, a lead heuristic may be the respective associated heuristic of a customer perspective. For example, the lead heuristic may include using the first utterance containing at least a minimum number of tokens of an agent perspective for a summary from the agent's perspective. As one example, the minimum number of tokens may be five tokens. As another example, a long heuristic may be the respective associated heuristic of an agent perspective. For example, the long heuristic may include using the longest utterance of an agent perspective for a summary from the agent's perspective. In various examples, the weakly labeled data may thus include a weakly labeled summary of each of the groups for each of the perspectives.

At block 308, the processor inter-trains a pre-trained model for each different perspective based on respective weakly labeled data. For example, given a dialog from the number of groups, the processor may train the model to generate its respective weak summary from the weakly labeled data. In some examples, the processor can masking a target utterance in inter-training the pre-trained model.

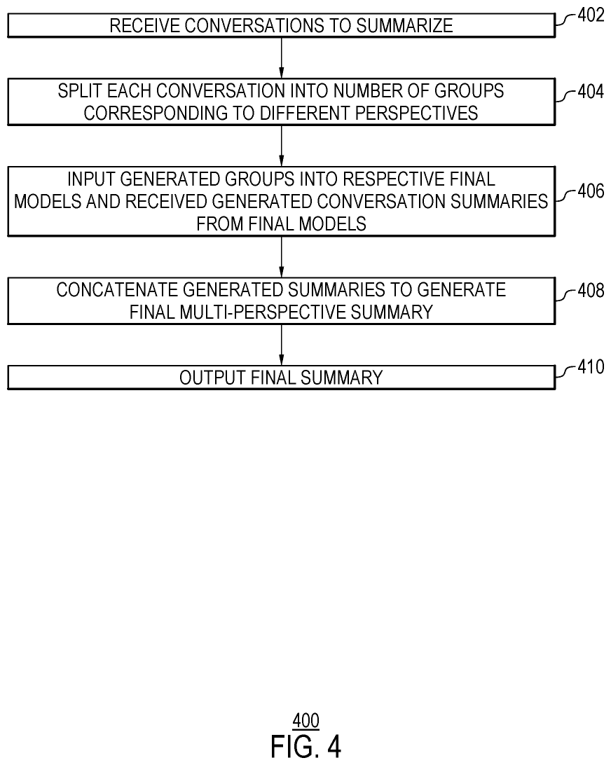

At block 310, the processor fine-tunes each inter-trained model based on the few-shot training data for each different perspective to generate a final model for each different perspective. For example, the final models may then be used to summarize conversations, as described in the example method 400 of FIG. 4 below.

The process flow diagram of FIG. 3 is not intended to indicate that the operations of the method 300 are to be executed in any particular order, or that all of the operations of the method 300 are to be included in every case. Additionally, the method 300 can include any suitable number of additional operations.

FIG. 4 is a process flow diagram of an example method that can summarize input conversations using models trained using heuristic-based inter-training. The method 400 can be implemented with any suitable computing device, such as the computing device 500 of FIG. 5 and is described with reference to the system 200 of FIG. 2.

At block 402, a processor receives conversations to summarize. As one example, the each of the conversations may be between a customer and an agent. In various examples, the conversation may be between any two or more sources.

At block 404, the processor splits each of the conversations to generate a number of groups corresponding to different perspectives. For example, each of the groups may be a list of sentences associated with each different perspective of a given conversation.

At block 406, the processor inputs the generated groups into respective final models and receives a generated conversation summary from the final models. For example, each generated conversation summary may be a summary of a conversation from the associated perspective. In some examples, the processor may then add a prefix of indirect speech clause to a generated conversation summary in response to detecting that a generated conversation summary does not begin with any prefix of indirect speech clause.

At block 408, the processor concatenates the summaries to generate a final multi-perspective summary. For example, the final multi-perspective summary may include a summary of the conversion from multiple perspectives.

At block 410, the processor outputs the final multi-perspective summary. For example, the final multi-perspective summary may be output to a client device that provided the conversation.

The process flow diagram of FIG. 4 is not intended to indicate that the operations of the method 400 are to be executed in any particular order, or that all of the operations of the method 400 are to be included in every case. Additionally, the method 400 can include any suitable number of additional operations.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

FIG. 5 is block diagram of an example computing device that can perform heuristic-based inter-training of a machine learning network. The computing device 500 may be for example, a server, desktop computer, laptop computer, tablet computer, or smartphone. In some examples, computing device 500 may be a cloud computing node. Computing device 500 may be described in the general context of computer system executable instructions, such as program modules, being executed by a computer system. Generally, program modules may include routines, programs, objects, components, logic, data structures, and so on that perform particular tasks or implement particular abstract data types. Computing device 500 may be practiced in distributed cloud computing environments where tasks are performed by remote processing devices that are linked through a communications network. In a distributed cloud computing environment, program modules may be located in both local and remote computer system storage media including memory storage devices.

The computing device 500 may include a processor 502 that is to execute stored instructions, a memory device 504 to provide temporary memory space for operations of said instructions during operation. The processor can be a single-core processor, multi-core processor, computing cluster, or any number of other configurations. The memory 504 can include random access memory (RAM), read only memory, flash memory, or any other suitable memory systems.

The processor 502 may be connected through a system interconnect 506 (e.g., PCI®, PCI-Express®, etc.) to an input/output (I/O) device interface 508 adapted to connect the computing device 500 to one or more I/O devices 510. The I/O devices 510 may include, for example, a keyboard and a pointing device, wherein the pointing device may include a touchpad or a touchscreen, among others. The I/O devices 510 may be built-in components of the computing device 500, or may be devices that are externally connected to the computing device 500.

The processor 502 may also be linked through the system interconnect 506 to a display interface 512 adapted to connect the computing device 500 to a display device 514. The display device 514 may include a display screen that is a built-in component of the computing device 500. The display device 514 may also include a computer monitor, television, or projector, among others, that is externally connected to the computing device 500. In addition, a network interface controller (NIC) 516 may be adapted to connect the computing device 500 through the system interconnect 506 to the network 518. In some embodiments, the NIC 516 can transmit data using any suitable interface or protocol, such as the internet small computer system interface, among others. The network 518 may be a cellular network, a radio network, a wide area network (WAN), a local area network (LAN), or the Internet, among others. An external computing device 520 may connect to the computing device 500 through the network 518. In some examples, external computing device 520 may be an external webserver 520. In some examples, external computing device 520 may be a cloud computing node.

The processor 502 may also be linked through the system interconnect 506 to a storage device 522 that can include a hard drive, an optical drive, a USB flash drive, an array of drives, or any combinations thereof. In some examples, the storage device may include a receiver module 524, a perspective splitter module 526, a heuristic-based labeler module 528, an inter-trainer module 530, and a fine-tuner module 532. The receiver module 524 can receive unlabeled data, few-shot training data, and a pre-trained model. In various examples, the few-shot training data may include 64 samples or less. In some examples, the receive module 524 can also receive conversations to summarize. In some examples, the pre-trained model may be a pre-trained generative model. The perspective splitter module 526 can split the unlabeled data into a number of groups corresponding to different perspectives. For example, each of the number of groups may each include a list of sentences associated with a particular perspective of the number of different perspectives. In some examples, the perspective splitter module 526 can also split received conversations into a second number of groups corresponding to the different perspectives. The heuristic-based labeler module 528 can generate weakly labeled data for each of the number of groups using a respective associated heuristic. For example, a respective associated heuristic for one of the number of groups may be different from a respective associated heuristic for another of the number of groups. The weakly labeled data comprises a summary automatically generated using the respective associated heuristic. In various examples, the weakly labeled data may include dialog-summary pairs. As one example, the associated heuristic may be a lead heuristic or a long heuristic. The inter-trainer module 530 may then inter-train the pre-trained model for each perspective based on respective weakly labeled data. In some examples, the inter-trainer module 530 can also mask a target utterance in inter-training the pre-trained model. The fine-tuner module 532 can fine-tune each inter-trained model based on the few-shot training data for each different perspective to generate a final model for each different perspective.

It is to be understood that the block diagram of FIG. 5 is not intended to indicate that the computing device 500 is to include all of the components shown in FIG. 5. Rather, the computing device 500 can include fewer or additional components not illustrated in FIG. 5 (e.g., additional memory components, embedded controllers, modules, additional network interfaces, etc.). For example, the computing device 500 may include an inference module (not shown) that can input each of the second number of groups into a respective final model for each different perspective and receive a generated conversation summary for each of the second number of groups from each respective final model. The computing device 500 may further include a concatenator module (not shown) to concatenate the generated conversation summaries to generate a final multi-perspective summary and output the final multi-perspective summary. In some examples, the computing device 500 may include a prefix adder (not shown) to add a prefix of indirect speech clause to a generated conversation summary in response to detecting that a generated conversation summary does not begin with any prefix of indirect speech clause. Furthermore, any of the functionalities of the receiver module 524, the perspective splitter module 526, the heuristic-based labeler module 528, the inter-trainer module 530, and the fine-tuner module 532 may be partially, or entirely, implemented in hardware and/or in the processor 502. For example, the functionality may be implemented with an application specific integrated circuit, logic implemented in an embedded controller, or in logic implemented in the processor 502, among others. In some embodiments, the functionalities of the receiver module 524, the perspective splitter module 526, the heuristic-based labeler module 528, the inter-trainer module 530, and the fine-tuner module 532 can be implemented with logic, wherein the logic, as referred to herein, can include any suitable hardware (e.g., a processor, among others), software (e.g., an application, among others), firmware, or any suitable combination of hardware, software, and firmware.

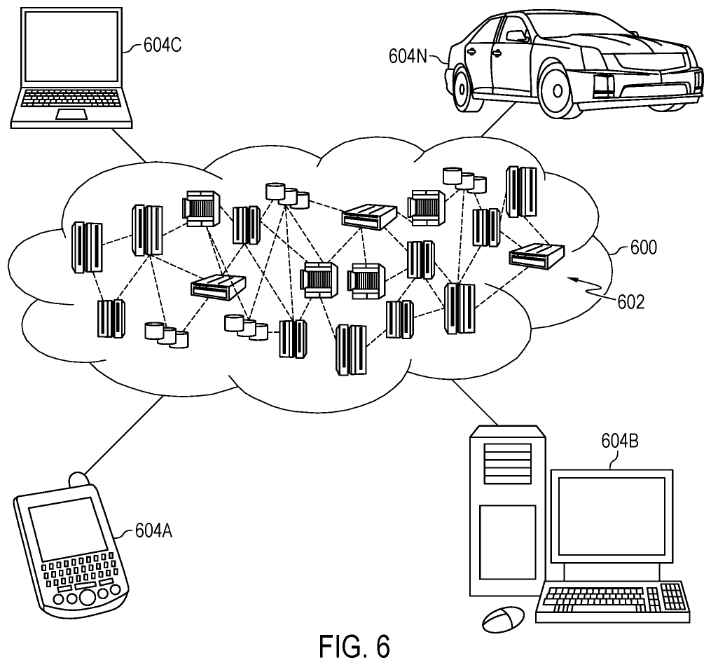

Referring now to FIG. 6, illustrative cloud computing environment 600 is depicted. As shown, cloud computing environment 600 includes one or more cloud computing nodes 602 with which local computing devices used by cloud consumers, such as, for example, personal digital assistant (PDA) or cellular telephone 604A, desktop computer 604B, laptop computer 604C, and/or automobile computer system 604N may communicate. Nodes 602 may communicate with one another. They may be grouped (not shown) physically or virtually, in one or more networks, such as Private, Community, Public, or Hybrid clouds as described hereinabove, or a combination thereof. This allows cloud computing environment 600 to offer infrastructure, platforms and/or software as services for which a cloud consumer does not need to maintain resources on a local computing device. It is understood that the types of computing devices 604A-N shown in FIG. 6 are intended to be illustrative only and that computing nodes 602 and cloud computing environment 600 can communicate with any type of computerized device over any type of network and/or network addressable connection (e.g., using a web browser).

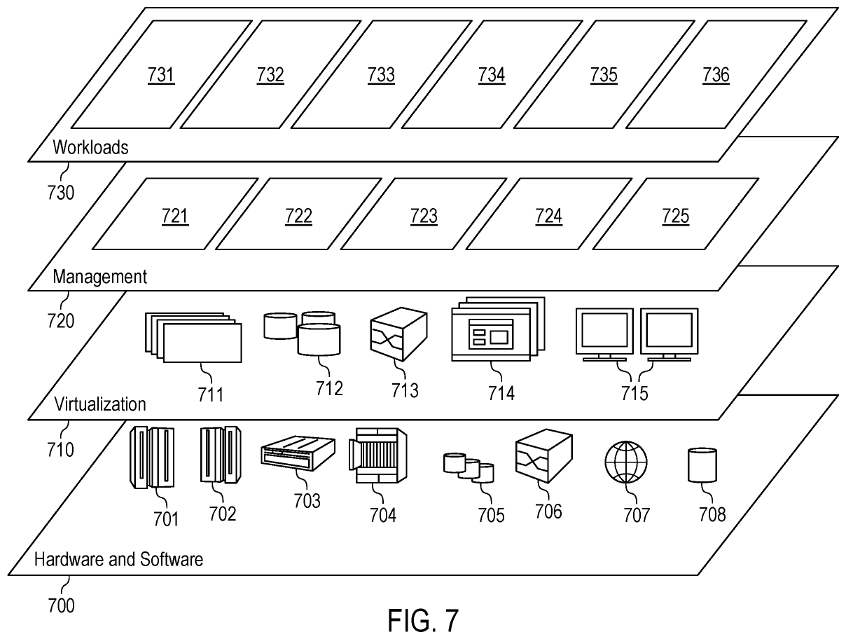

Referring now to FIG. 7, a set of functional abstraction layers provided by cloud computing environment 600 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 700 includes hardware and software components. Examples of hardware components include: mainframes 701; RISC (Reduced Instruction Set Computer) architecture based servers 702; servers 703; blade servers 704; storage devices 705; and networks and networking components 706. In some embodiments, software components include network application server software 707 and database software 708.

Virtualization layer 710 provides an abstraction layer from which the following examples of virtual entities may be provided: virtual servers 711; virtual storage 712; virtual networks 713, including virtual private networks; virtual applications and operating systems 714; and virtual clients 715.

In one example, management layer 720 may provide the functions described below. Resource provisioning 721 provides dynamic procurement of computing resources and other resources that are utilized to perform tasks within the cloud computing environment. Metering and Pricing 722 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 723 provides access to the cloud computing environment for consumers and system administrators. Service level management 724 provides cloud computing resource allocation and management such that required service levels are met. Service Level Agreement (SLA) planning and fulfillment 725 provide pre-arrangement for, and procurement of, cloud computing resources for which a future requirement is anticipated in accordance with an SLA.

Workloads layer 730 provides examples of functionality for which the cloud computing environment may be utilized. Examples of workloads and functions which may be provided from this layer include: mapping and navigation 731; software development and lifecycle management 732; virtual classroom education delivery 733; data analytics processing 734; transaction processing 735; and heuristic-based machine learning model training 736.

The present invention may be a system, a method and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the techniques. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Referring now to FIG. 8, a block diagram is depicted of an example tangible, non-transitory computer-readable medium 800 that can perform heuristic-based inter-training of a machine learning network. The tangible, non-transitory, computer-readable medium 800 may be accessed by a processor 802 over a computer interconnect 804. Furthermore, the tangible, non-transitory, computer-readable medium 800 may include code to direct the processor 802 to perform the operations of the methods 300 and 400 of FIGS. 3 and 4.

The various software components discussed herein may be stored on the tangible, non-transitory, computer-readable medium 800, as indicated in FIG. 8. For example, a receiver module 806 includes code to receive unlabeled data, few-shot training data, and a pre-trained model. In some examples, the receiver module 806 may also include code to receive a conversation to summarize. A perspective splitter module 808 includes code to split the unlabeled data into a number of groups corresponding to perspectives. In some examples, the perspective splitter module 808 includes code to split the conversation into a second number of groups corresponding to the perspectives. A heuristic-based labeler module 810 includes code to generate weakly labeled data for each of the number of groups using a respective associated heuristic. For example, the heuristic-based labeler module 810 may include code to generate dialog-summary pairs. An inter-trainer module 812 includes code to inter-trains a model for each perspective based on respective weakly labeled data. In some examples, the inter-trainer module 812 may include code to mask a target utterance in inter-training the pre-trained model. A fine-tuner module 814 includes code to fine-tune each inter-trained model based on the few-shot training data for each perspective to generate a final model for each perspective.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. It is to be understood that any number of additional software components not shown in FIG. 8 may be included within the tangible, non-transitory, computer-readable medium 800, depending on the specific application. The computer-readable medium 800 may further include an inference module (not shown) to input each of the second number of groups into a respective final model for each perspective and receive a generated conversation summary for each of the second number of groups from each respective final model. In some examples, the inference module may further include code to concatenate the generated conversation summaries to generate a final multi-perspective summary and output the final multi-perspective summary. In some examples, the computer-readable medium 800 may also include code to add a prefix of indirect speech clause to a generated conversation summary in response to detecting that a generated conversation summary does not begin with any prefix of indirect speech clause.

The descriptions of the various embodiments of the present techniques have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising a processor to:
split unlabeled data into a plurality of groups corresponding to different perspectives;
generate weakly labeled data for each of the plurality of groups using a respective associated heuristic;
inter-train a pre-trained model for each perspective based on respective weakly labeled data; and
fine-tune each inter-trained model based on few-shot training data for each different perspective to generate a final model for each different perspective.

2. The system of claim 1, wherein the processor is to further:
receive a conversation to summarize;
split the conversation into a second plurality of groups corresponding to the different perspectives; and
input each of the second plurality of groups into a respective final model for each different perspective and receive a generated conversation summary for each of the second plurality of groups from each respective final model.

3. The system of claim 2, wherein the processor is to:
concatenate the generated conversation summaries to generate a final multi-perspective summary; and
output the final multi-perspective summary.

4. The system of claim 2, wherein the processor is to add a prefix of indirect speech clause to a generated conversation summary in response to detecting that a generated conversation summary does not begin with any prefix of indirect speech clause.

5. The system of claim 1, wherein the weakly labeled data comprises a summary automatically generated using the respective associated heuristic.

6. The system of claim 1, wherein the pre-trained model comprises a pre-trained generative model.

7. The system of claim 1, wherein a respective associated heuristic for one of the plurality of groups is different from a respective associated heuristic for another of the plurality of groups.

8. The system of claim 1, wherein the plurality of groups each comprise a list of sentences associated with a particular perspective of the plurality of different perspectives.

9. The system of claim 1, wherein the processor is to mask a target utterance in inter-training the pre-trained model.

10. The system of claim 1, wherein the weakly labeled data comprises dialog-summary pairs.

11. A computer-implemented method, comprising:
receiving, via a processor, unlabeled data, few-shot training data, and a pre-trained model;
splitting, via the processor, the unlabeled data into a plurality of groups corresponding to different perspectives;
generating, via the processor, weakly labeled data for each of the plurality of groups using a respective associated heuristic;
inter-training, via the processor, the pre-trained model for each different perspective based on respective weakly labeled data; and
fine-tuning, via the processor, each inter-trained model based on the few-shot training data for each different perspective to generate a final model for each different perspective.

12. The computer-implemented method of claim 10, further comprising:
receiving, via the processor, a conversation to summarize;
splitting, via the processor, the conversation into a second plurality of groups corresponding to the different perspectives; and
inputting, via the processor, each of the second plurality of groups into a respective final model for each different perspective; and
receiving, via the processor, a generated conversation summary for each of the second plurality of groups from each respective final model.

13. The computer-implemented method of claim 12, further comprising adding a prefix of indirect speech clause to a generated conversation summary in response to detecting that a generated conversation summary does not begin with any prefix of indirect speech clause.

14. The computer-implemented method of claim 12, further comprising:
concatenating, via the processor, the generated conversation summaries to generate a final multi-perspective summary; and
outputting, via the processor, the final multi-perspective summary.

15. The computer-implemented method of claim 11, wherein inter-training the pre-trained model comprises masking a target utterance.

16. A computer program product for training neural networks, the computer program product comprising a computer-readable storage medium having program code embodied therewith, the program code executable by a processor to cause the processor to:
receive unlabeled data, few-shot training data, and a pre-trained model;
split the unlabeled data into a plurality of groups corresponding to different perspectives;
generate weakly labeled data for each of the plurality of groups using a respective associated heuristic;
inter-train the pre-trained model for each different perspective based on respective weakly labeled data; and
fine-tune each inter-trained model based on the few-shot training data for each different perspective to generate a final model for each different perspective.

17. The computer program product of claim 16, further comprising program code executable by the processor to:
receive a conversation to summarize;
split the conversation into a second plurality of groups corresponding to the different perspectives; and
input each of the second plurality of groups into a respective final model for each different perspective and receive a generated conversation summary for each of the second plurality of groups from each respective final model.

18. The computer program product of claim 17, further comprising program code executable by the processor to add a prefix of indirect speech clause to a generated conversation summary in response to detecting that a generated conversation summary does not begin with any prefix of indirect speech clause.

19. The computer program product of claim 17, further comprising program code executable by the processor to:
concatenate the generated conversation summaries to generate a final multi-perspective summary; and
output the final multi-perspective summary.

20. The computer program product of claim 16, further comprising program code executable by the processor to mask a target utterance in inter-training the pre-trained model.
